(19) United States
(12) Patent Application Publication
(10) Pub. No.: US 2017/0091343 A1
(43) Pub. Date: Mar. 30, 2017

(54) METHOD AND APPARATUS FOR CLUSTERING SEARCH QUERY SUGGESTIONS

(71) Applicant: YANDEX EUROPE AG, Luzern (CH)

(72) Inventors: Svetlana Jurievna SHORINA, Moscow (RU); Andrey Grigorievich PLAKHOV, Sergiev Posad (RU); Ivan Georgievich YANIKOV, Moscow (RU)

(21) Appl. No.: 15/263,509

(22) Filed: Sep. 13, 2016

(30) Foreign Application Priority Data
Sep. 29, 2015 (RU) 2015141341

(51) Int. Cl. G06F 17/30

(52) U.S. Cl. CPC G06F 17/30973; G06F 17/3053; G06F 17/30991; G06F 17/30598

(57) ABSTRACT

A method and system for generating a list of search query suggestions is provided. At least a portion of a search query is received from a user, and a ranked plurality of search query suggestions for the portion of the search query is generated. It is determined, based at least in part on an association parameter, whether each search query suggestion is associated with a particular search source, the association parameter defining the degree of relevancy of each suggestion to each respective search source. A suggestion group is created for each respective associated search source. The suggestion group presents the subset of search query suggestions associated with the respective search source. Finally, the list of search query suggestions is generated, each respective subset being grouped together in each respective suggestion group, and each suggestion group being displayed separately.

### CROSS-REFERENCE

The present application claims priority to Russian Patent Application No. 2015141341, filed Sep. 29, 2015, entitled “METHOD AND APPARATUS FOR CLUSTERING SEARCH QUERY SUGGESTIONS”, the entirety of which is incorporated herein by reference.

### FIELD

The present technology relates to search engines in general and specifically to a method and apparatus for generating a list of search query suggestions.

### BACKGROUND

Various global or local communication networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment related information. Users use a variety of client devices (desktop, laptop, notebook, smartphone, tablets and the like) to have access to rich content (like images, audio, video, animation, and other multimedia content from such networks).

Generally speaking, a given user can access a resource on the communication network by two principle means. The given user can access a particular resource directly, either by typing an address of the resource (typically an URL or Universal Resource Locator, such as www.webpage.com) or by clicking a link in an e-mail or in another web resource. Alternatively, the given user may conduct a search using a search engine to locate a resource of interest. The latter is particularly suitable in those circumstances, where the given user knows a topic of interest, but does not know the exact address of the resource she is interested in.

When the given user runs a web search using the search engine, he or she generally has two priorities. He or she wants the search engine to locate the most relevant results and he or she wants the results relatively quickly. To at least partially address these concerns, it is known to present the user using a search engine with query suggestions. For example, in response to a user typing a query “Molly” into the Google™ search engine, the user gets a list of suggestions in a drop down menu, namely “Molly Ringwald”, “Molly Maid”, etc. The general idea behind the suggestions is to enable a more user-friendly search experience and to assist the user in exploring a subject of interest. For example, the user may not know exactly what query will provide the information he or she wants; search suggestions can help the user to find desired or related information. The user then can browse the search results and select a link that he or she is desirous of perusing.

Thus, in order to assist the person conducting the search, a search engine can suggest additional queries to the searcher. There are a variety of technologies the search engine can use to identify the additional queries, and each of these technologies will typically result in a large set of queries that the engine can potentially suggest. However, improvements can be made to provide a more satisfying search experience to the searcher.

U.S. Patent Application Publication No. 2011/0161311 published on Jun. 30, 2011 teaches methods and apparatus for clustering and presenting search suggestions. A segment of text is obtained via a search query section of a user interface, the segment of text being a portion of a search query. A set of suggestions is obtained, each suggestion in the set of suggestions being a suggested search query relating to the segment of text. Two or more groups of suggestions are generated, each of the two or more groups of suggestions including a different subset of the set of suggestions. The two or more groups of suggestions are provided such that each of the two or more groups of suggestions is displayed in a separate partition of a search assistance segment of the user interface.

U.S. Patent Application Publication No. 2012/0330962 published on May 24, 2012 teaches a method of providing suggested terms. The method includes receiving an initial query input from a user, and obtaining corresponding suggested queries based on the initial query; determining at least two categories corresponding to the suggested queries and at least two clickable regions usable for looking up the suggested queries; separately determining a category weight associated with each obtained category in each clickable region for the suggested queries, and a click attribute weight associated with each clickable region; computing a degree of confidence of each category for the suggested queries; and separately determining target categories for the suggested queries based on the degree of confidence of each category for the suggested queries. As such, the user may quickly identify his/her search intention based on the target categories corresponding to the suggested queries, thereby effectively improving the speed of information searching.

U.S. Patent Application Publication No. 2015/0006505 published on Jan. 1, 2015 teaches a method of and system for displaying by a client application in communication with a search engine a plurality of user-selectable refinements to a search query including a search term. The method includes sending the search query; receiving search results and suggested search query refinements determined based at least in part on an analysis of groups of related search queries, each suggested search query refinement corresponding to a refined search query including the search term and an additional search term; displaying search results and, apart from a search bar, refinements, refinements being selectable by a user via a graphical object; receiving a selection of one of the refinements, the selection corresponding to a refined search query including the search term and an additional search term; receiving refined search results; and displaying refined search results and a visual representation of a refinement relationship between the search query and the refined search query.

### SUMMARY

It is an object of the present technology to ameliorate at least some of the inconveniences present in the prior art.

In one aspect, implementations of the present technology provide a method of generating a list of search query suggestions. The method can be executable at a server. The method comprises receiving at least a portion of a search query from a user, and generating a ranked plurality of search query suggestions for the portion of the search query. Based at least in part on an association parameter, it is determined whether each search query suggestion is associated with a respective search source. The association parameter defines the degree of relevancy of each search query suggestion to each respective search source. Responsive to determining that a search query suggestion is associated with the respective search source, a suggestion group for each respective search source is created, each suggestion group being for presentation of a respective subset of the plurality of search query suggestions, the respective subset including only search query suggestions associated with the respective search source. The list of search query suggestions is then generated, wherein each respective subset is grouped together in each respective suggestion group, each suggestion group being displayed separately in the list.

In some implementations, two or more suggestion groups are created, each suggestion group associated with a unique respective search source. In some implementations, for one or more suggestion group, the respective subset associated with the respective suggestion group includes two or more search query suggestions. Each suggestion group may be presented with a heading indicating the respective associated search source, the respective subset of search query suggestions associated with the respective search source being grouped together under the respective heading.

In some implementations, the search source is a vertical search domain. Non-limiting examples of vertical search domains include news, images, pictures, videos, people, local businesses, items for sale, weather forecasts, maps, movies, food, recipes, and combinations thereof.

In some implementations, the method further comprises the step of causing the list of search query suggestions to be displayed to the user. In such implementations, the method may further comprise the step of, responsive to the user selecting a search query suggestion presented in the respective suggestion group, executing a search of the respective search source associated with the respective suggestion group.

In some implementations, the method further comprises the step of, responsive to determining that a search query suggestion is not associated with the respective search source, causing the non-associated search query suggestion to be displayed in the list separately from each suggestion group, such that suggestion groups and non-associated search query suggestions are mixed together in the list.

In some implementations, association between a search query suggestion and the respective search source is indicated by the association parameter being above a predetermined threshold.

In some implementations, the association parameter has been predetermined based on a training set of user data for past user interaction with a search query suggestion and the respective search source in response to the past user having inputted the search query. The training set of user data may comprise historical user search data or user-specific search data.

In another aspect, implementations of the present technology provide a server. The server comprises a communication interface for communication with an electronic device associated with a user via a communication network, a memory storage, and a processor operationally connected with the communication interface and the memory storage, the processor configured to store objects, in association with the user, on the memory storage. The processor is further configured to receive at least a portion of a search query from a user, and generate a ranked plurality of search query suggestions for the portion of the search query. Based at least in part on an association parameter, the processor is configured to determine whether each search query suggestion is associated with a respective search source, the association parameter defining the degree of relevancy of each search query suggestion to each respective search source. Responsive to determining that a search query suggestion is associated with the respective search source, the processor is configured to create a suggestion group for each respective search source, each suggestion group being for presentation of a respective subset of the plurality of search query suggestions, the respective subset including only search query suggestions associated with the respective search source. The processor is also configured to generate the list of search query suggestions, wherein each respective subset is grouped together in each respective suggestion group, each suggestion group being displayed separately.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein. The terms “client device” and “electronic device” are used interchangeably herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the expression “search query” is intended to include any type of request including one or more search terms that can be submitted to a search engine (or multiple search engines) for identifying search result items, and/or component(s) thereof, based on the search term(s) contained in the search query. The search result items or components thereof that are identified by the search queries in the data structure are representations of results produced in response to the search queries. For example, the search result items can be web results, instant answers, etc.

In the context of the present specification, the expression “general domain” is intended to include general content, for example, indexed internet content or web content. For example, a general domain search is not confined to search a specific category of results but is able to provide all results that best match the search query. Such a general (category-independent) search by a search engine may return search results that include non-category specific digital content as well as category specific digital content, such as images, videos, news, shopping, blogs, books, places, discussions, recipes, patents, stocks, timelines, etc., and other digital content that is closely related and directed toward a certain type of digital content. As an example, a general domain search may be a WWW search. A search performed in a general domain generates a “general search result” or “general search result item.” Such general search results are also referred to herein as “web results.” Typically, a web result includes a website link and a snippet that summarizes content of the website. A user may select a website link of a web result to navigate to the webpage related to the user search query. The terms “general search result” and “general search result item” are used interchangeably herein, as are the terms “search result” and “search result item.”

In the context of the present specification, the expression “vertical domain” is intended to include an information domain containing specialized content, such as content of a single type (e.g., media type, genre of content, topicality, etc.). A vertical domain thus includes a specific subset of a larger set of data, for example, a specific subset of web data. For example, a vertical domain may include specific information such as news, images, pictures, videos, local businesses, items for sale, weather forecasts, maps, movies, recipes, etc. A search performed in a vertical domain generates a “vertical search result” or a “vertical search result item.” Such vertical search results are also referred to herein as “verticals” and “vertical results.” The terms “vertical search result” and “vertical search result item” are used interchangeably herein.

In the context of the present specification, the expression “plurality of search results” is intended to include a set of more than one search result, where general (e.g., Web) search results and/or vertical search results are integrated together within the set of search results or on a search results page. For example, vertical search results may be integrated into general (e.g., Web) search results within a search results page, or vice-versa, i.e., general search results may be integrated into vertical search results within a search results page. Thus, in some embodiments, general search results and vertical search results may be aggregated and ranked relative to each other. In alternative embodiments, a plurality of search results may include only general search results or only vertical search results, e.g., search results from a particular vertical domain of interest.

In the context of the present specification, the expression “search source” is intended to refer to an information domain containing specialized content, such as content of a single type (e.g., media type, genre of content, topicality, etc.), as well as to search services for searching exclusively within such information domains. A search source may be, for example, a vertical domain and/or a search service that generates relevant search results from a particular vertical or information domain.

In the context of the present specification, the expression “association parameter” is intended to include a tool that is based on the degree of relevancy of a search query or a search query suggestion to a particular search source and is used to determine whether a search query suggestion is associated with a particular search source. The term “association,” as used herein, generally reflects the relevance, importance, interest, and/or applicability of a particular search query suggestion in relation to a particular search source. The association parameter is generally determined based on a training set of user data for past user interaction with a search query suggestion and a particular search source, in response to a search query. For example, a past user may have inputted a search query and then selected search result items related to a particular vertical, searching further in relation to the search query only in that particular vertical domain. Based at least in part on user behavior with respect to the search query and the particular vertical domain, it may be determined that the particular vertical domain is especially relevant or useful to the search query. Association of the search query with the particular vertical domain is then determined, and the association parameter is generated accordingly.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation.

Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram depicting a system, the system being implemented in accordance with non-limiting embodiments of the present technology.

FIG. 2 is a schematic representation of a screen shot of the electronic device of the system of FIG. 1, the electronic device being implemented in accordance with non-limiting embodiments of the present technology.

FIG. 3 is a schematic representation of a screen shot of the electronic device of the system of FIG. 1, the electronic device being implemented in accordance with non-limiting embodiments of the present technology.

FIG. 4 depicts a block diagram of a method, the method being executable within the system of FIG. 1 and being implemented in accordance with non-limiting embodiments of the present technology.

### DETAILED DESCRIPTION

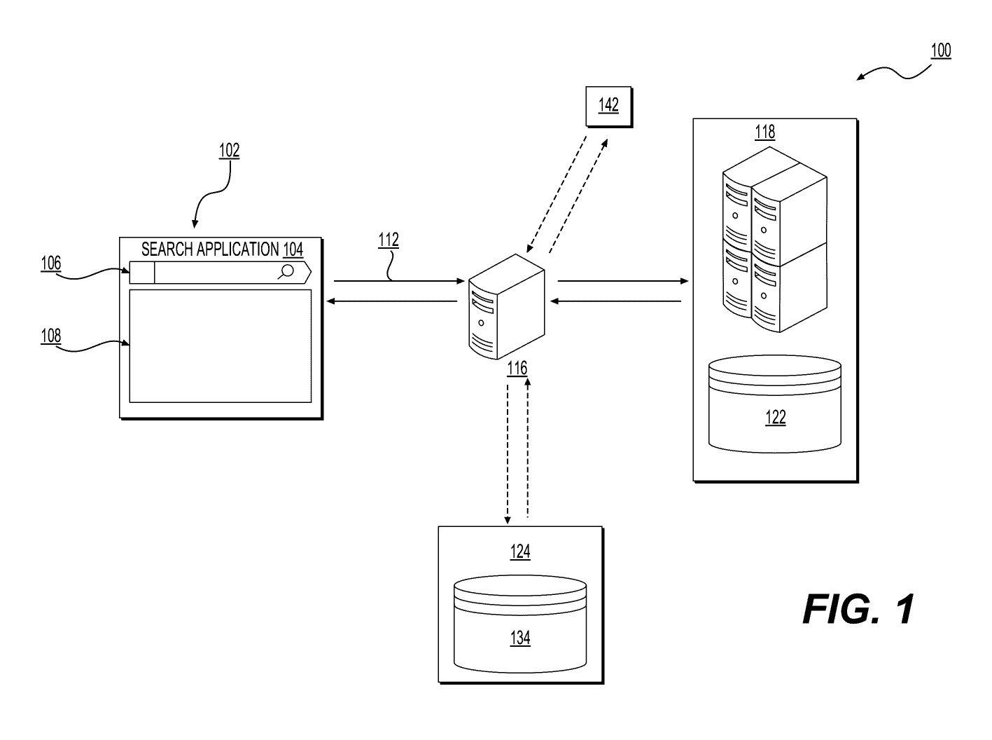

Referring to FIG. 1, there is shown a schematic diagram of a system 100, the system 100 being suitable for implementing non-limiting embodiments of the present technology. It is to be expressly understood that the system 100 as depicted is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

Generally speaking, the system 100 is configured to receive search queries and to conduct web searches (e.g., general searches, vertical searches) in response thereto, as well as to process search queries in accordance with non-limiting embodiments of the present technology. As such, any system variation configured to process user search queries can be adapted to execute embodiments of the present technology, once teachings presented herein are appreciated.

The system 100 comprises an electronic device 102. The electronic device 102 is typically associated with a user (not depicted) and, as such, can sometimes be referred to as a “client device”. It should be noted that the fact that the electronic device 102 is associated with the user does not need to suggest or imply any mode of operation—such as a need to log in, a need to be registered, or the like.

The implementation of the electronic device 102 is not particularly limited, but as an example, the electronic device 102 may be implemented as a personal computer (desktops, laptops, netbooks, etc.), a wireless communication device (such as a smartphone, a cell phone, a tablet and the like), as well as network equipment (such as routers, switches, and gateways). The electronic device 102 comprises hardware and/or software and/or firmware (or a combination thereof), as is known in the art, to execute a search application 104. Generally speaking, the purpose of the search application 104 is to enable the user (not depicted) to execute a search, such as the above mentioned web search using the above-mentioned search engine.

How the search application 104 is implemented is not particularly limited. One example of the search application 104 may include a user accessing a web site associated with a search engine to access the search application 104. For example, the search application can be accessed by typing in an URL associated with Yandex™ search engine at www.yandex.ru. It should be expressly understood that the search application 104 can be accessed using any other commercially available or proprietary search engine.

In alternative non-limiting embodiments of the present technology, the search application 104 may be implemented as a browser application on a portable device (such as a wireless communication device). For example (but not limited to) those implementations, where the electronic device 102 is implemented as a portable device, such as for example, Samsung™ Galaxy™ SIII, the electronic device may be executing a Yandex browser application. It should be expressly understood that any other commercially available or proprietary browser application can be used for implementing non-limiting embodiments of the present technology.

Generally speaking, the search application 104 comprises a search query interface 106 and a search result interface 108. The general purpose of the search query interface 106 is to enable the user (not depicted) to enter his or her search query or a portion thereof, e.g., a “search string”. The general purpose of the search result interface 108 is to provide search results that are responsive to the user search query entered into the search query interface 106. How the user search query is processed and how the search results are presented will be described in detail herein below.

Also coupled to a communication network (not depicted) is a server 116. The server 116 can be implemented as a conventional computer server. In an example of an embodiment of the present technology, the server 116 can be implemented as a Dell™ PowerEdge™ Server running the Microsoft™ Windows Server™ operating system. Needless to say, the server 116 can be implemented in any other suitable hardware, software, and/or firmware, or a combination thereof. In the depicted non-limiting embodiments of the present technology, the server 116 is a single server. In alternative non-limiting embodiments of the present technology, the functionality of the server 116 may be distributed and may be implemented via multiple servers.

The electronic device 102 is configured to communicate with the server 116 over a communication link 112. Generally speaking, the communication link 112 enables the electronic device 102 to access the server 116 via the communication network (not depicted). In some non-limiting embodiments of the present technology, the communication network (not depicted) can be implemented as the Internet. In other embodiments of the present technology, the communication network (not depicted) can be implemented differently, such as any wide-area communication network, local-area communication network, a private communication network and the like.

How the communication link 112 is implemented is not particularly limited and will depend on how the electronic device 102 is implemented. Merely as an example and not as a limitation, in those embodiments of the present technology where the electronic device 102 is implemented as a wireless communication device (such as a smartphone), the communication link 112 can be implemented as a wireless communication link (such as but not limited to, a 3G communication network link, a 4G communication network link, Wireless Fidelity, or WiFi® for short, Bluetooth® and the like). In those examples where the electronic device 102 is implemented as a notebook computer, the communication link 112 can be either wireless (such as Wireless Fidelity, or WiFi® for short, Bluetooth® or the like) or wired (such as an Ethernet based connection).

The server 116 is communicatively coupled (or otherwise has access) to a search cluster 118. According to some embodiments of the present technology, the search cluster 118 performs web searches (e.g., general and/or vertical searches) in response to the user search queries inputted via the search query interface 106 and outputs search results to be presented to the user using the search results interface 108. Within these non-limiting embodiments of the present technology, the search cluster 118 comprises or otherwise has access to a database 122. As is known to those of skill in the art, the database 122 stores information associated with a plurality of resources potentially accessible via the communication network (for example, those resources available on the Internet). The process of populating and maintaining the database 122 is generally known as “crawling”. It should be expressly understood that in order to simplify the description presented herein below, the configuration of the search cluster 118 has been greatly simplified. It is believed that those skilled in the art will be able to appreciate implementational details for the search cluster 118 and for components thereof.

The server 116 is communicatively coupled (or otherwise has access) to a search module 124. In the depicted non-limiting embodiment of the present technology, the search module 124 is a single vertical search module. In alternative non-limiting embodiments of the present technology, the server 116 is communicatively coupled (or otherwise has access) to a plurality of vertical search modules (not depicted). For example, merely for the purposes of ease of illustration, vertical search module 124 may be implemented as a vertical search module for searching pictures. Additional vertical search modules for searching additional vertical domains, for example maps and other geographical information, weather-related information, movies and the like, may be included. It should be expressly understood that a number of additional or different services can be implemented as part of the plurality of vertical search modules (not depicted), and that the number of modules within the plurality of vertical search modules is not meant to be limited.

In the depicted non-limiting embodiment of the present technology, vertical search module 124 comprises or has access to one or more database 134. In alternative non-limiting embodiments of the present technology having a plurality of vertical search modules (not depicted), it should be understood that any given one of the plurality of vertical search modules (not depicted) comprises or has access to one or more databases (not depicted). These one or more databases host data associated with the particular services implemented by the given one of the plurality of vertical search modules (not depicted).

To the extent that vertical search module 124 has access to database 134, recalling that the vertical search module 124 implements pictures, the database 134 contains pictures and related information.

Additionally or optionally and, as known to those skilled in the art, the one or more database 134 may be segregated into one or more separate databases (not depicted). These segregated databases may be portions of the same physical database or may be implemented as separate physical entities. For example, one database within, let's say, the database 134 could host the most popular/most frequently requested pictures for a given subject, while another database within the database 134 could host all the pictures available. Needless to say, the above has been provided as an illustration only and several additional possibilities exist for implementing embodiments of the present technology.

The vertical search module 124 is configured to perform vertical searches within the database 134. However, it should be noted that the search capabilities of the vertical search module 124 is not limited to searching the respective database 134 and the vertical search module 124 may perform other searches, as the need may be.

Also, for the purposes of the description presented herein, the term “vertical” (as in vertical search) is meant to connote a search performed on a subset of a larger set of data, e.g., a vertical domain, the subset having been grouped pursuant to an attribute of data. For example, to the extent that the vertical search module 124 is implemented as a pictures vertical domain, the vertical search module 124 searches a subset (i.e., pictures) of the set of data (i.e., all the data potentially available for searching), the subset of data being stored in the database 134.

Within these embodiments of the present technology, the server 116 is configured to access, separately and independently, the search cluster 118 (to perform a general web search, for example) and the vertical search module 124 (to perform the vertical search of pictures, for example). In alternative non-limiting embodiments of the present technology, the vertical search module 124 can be implemented as part of the search cluster 118. In those embodiments, the search cluster 118 can be responsible for coordinating and executing both the general web search and the vertical search. In some embodiments of the present technology, the search cluster 118 can execute a multi layer meta search by executing both the general web and the vertical searches.

Within the embodiment depicted in FIG. 1, the server 116 is generally configured to (i) conduct searches (by accessing the search cluster 118 and/or vertical search module 124); (ii) execute analysis of search results and perform ranking of search results; (iii) group search results and compile the search result page (SERP) to be outputted to the electronic device 102.

According to non-limiting embodiments of the present technology, the server 116 is further configured to generate a plurality of search query suggestions for the user entering a search query, or at least a portion thereof, into the search query interface 106. As is known to one skilled in the art, search suggestion is a feature whereby, responsive to the user entering a search query or at least a portion thereof, the search application 104 provides search suggestions related to the search query. For example, where the user has started typing in “Macaulay Culkin” and has only entered “Macaulay”, possible search query suggestions may include “Macaulay Culkin movies”, “Macaulay Culkin band”, “Macaulay Culkin wife” and the like. In accordance with embodiments of the present technology, the server 116 is configured to generate search query suggestions. In some embodiments, the search query suggestions can be text-based, image-based, based on a certain vertical source, and the like. For purposes of illustration only, in the examples described herein, search query suggestions are referred to as text strings, phrases, or words, however it should be expressly understood that the type of search query suggestion generated is not particularly limited. For example, a search query suggestion could be an image, an audio recording, etc.

To that end, the server 116 comprises or has access to a suggestion module 142. The operation of the suggestion module 142 within the context of generating a plurality of search query suggestions for a portion of a search query according to non-limiting embodiments of the present technology will now be described.

In the depicted non-limiting embodiment of the present technology, the suggestion module 142 is a single suggestion module. In alternative non-limiting embodiments of the present technology, the server 116 can be communicatively coupled (or otherwise has access) to a plurality of suggestion modules (not depicted). The suggestion module 142 can be configured to generate query suggestions for queries of any type. In some embodiments, a given implementation of the suggestion module 142 can be responsible for generating query suggestions of a particular type. For example, merely for the purposes of ease of illustration, suggestion module 142 may be implemented as a suggestion module for generating search query suggestions for search query components relating to movies. Additional suggestion modules for generating additional search query suggestions, for example for search query components related to people, videos, maps, and the like, may be included. It should be expressly understood that a number of additional or different services can be implemented as part of the plurality of suggestion modules (not depicted), and that the number of modules within the plurality of suggestion modules is not meant to be limited.

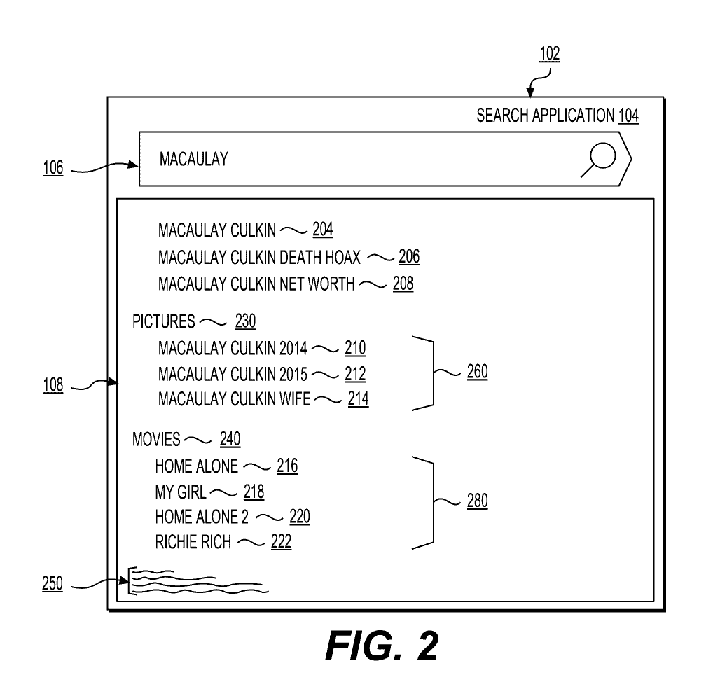

In order to fully appreciate implementations of the present technology, an example of the suggest window will be described in greater detail now. With reference to FIG. 2, there is depicted a screen shot of information displayed on the electronic device 102, much akin to the one in FIG. 1. The search application 104 includes the search query interface 106 and the search results interface 108. According to non-limiting embodiments of the present technology, there are also provided search query suggestions 204, 206, 208, 210, 212, 214, 216, 218, 220, and 222. In the non-limiting embodiment shown in FIG. 2, search query suggestions 210, 212, and 214 are grouped together in a first suggestion group 260 under the first heading 230 (“pictures”), each of the search query suggestions 210, 212, 214 in the first suggestion group being associated with the search source “pictures”. Search query suggestions 216, 218, 220, and 222 are grouped together in a second suggestion group 280 under the second heading 240 (“movies”), each of the search query suggestions 216, 218, 220, 222 being associated with the search source “movies”. Thus, first suggestion group 260 presents the subset of search query suggestions associated with the search source “pictures”, and second suggestion group 280 presents the subset of search query suggestions associated with the search source movies. Search query suggestions 204, 206, and 208 are not associated with a particular search source and are displayed in the search result page or SERP 108 separately from the suggestion groups 260, 280.

Generally speaking, search query suggestions 204-222 are presented in a distinct area of the search application 104. In some embodiments, the distinct area is at the top of the search result page or SERP 108, above the search results 250. However, in alternative embodiments of the present technology, the placement of the search query suggestions 204-222 can be different. By the same token, even though the search query suggestions 204-222 are depicted as all being displayed in a single distinct area, in alternative embodiments of the present technology, the search query suggestions 204-222 can be split into separate distinct areas and, in a sense, mixed with the rest of the information displayed within SERP 108. Further, although the search query suggestions 204-222 are displayed as text, it should be understood that these search query suggestions are provided as examples only, and other search query suggestions may be presented. For example, search query suggestions may be images, audio, and the like.

In some embodiments of the present technology and as depicted in FIG. 2, the search query suggestions 204-222 are presented in rows at the top of the SERP 108 and just below the search query interface 106. In alternative non-limiting embodiments of the present technology, the search query suggestions 204-222 can be located differently relative to the search query interface 106 and the search results 250. For example, in alternative implementations, the search query suggestions 204-222 may be positioned next, above or below portions of the search query interface 106 and the search results 250, and the like.

In alternative non-limiting embodiments of the present technology, the search query suggestions 204-222 may replace a portion of the search application 104, one or both of the search query interface 106 and the search results 250.

In some embodiments of the present technology, the search query suggestions 204-222 appear the moment the user has typed enough of a search query into the search query interface 106 to enable search query suggestion processing, as will be described below. In other words, the search query suggestions 204-222 can appear automatically in a sense of not requiring the user to take any affirmative actions. Alternatively, it is possible that search query suggestions 204-222 appear in response to the user positively indicating his or her intent to search query suggestion function.

In the depicted illustrative embodiment in FIG. 2, ten search query suggestions are shown—a first search query suggestion 204, a second search query suggestion 206, a third search query suggestion 208, a fourth search query suggestion 210, a fifth search query suggestion 212, a sixth search query suggestion 214, a seventh search query suggestion 216, an eighth search query suggestion 218, a ninth search query suggestion 220, and a tenth search query suggestion 222. It should be expressly understood that the number of search query suggestions is not particularly limited. For example, in some embodiments of the present technology, a single row of search query suggestions is displayed. In alternative non-limiting embodiments of the present technology, at least two or more rows of search query suggestions are displayed. Alternatively or additionally, the number of displayed search query suggestions can be dynamic, for example, based on the subject of the search query. In other words, as the suggestion module 142 generates additional alternatives for the search query suggestions, the number of suggestions displayed in the search results interface 108 can be dynamically increased.

It should be expressly understood that neither the number of search query suggestions displayed on a single row nor the number of rows is particularly limited. For example, in some embodiments of the present technology, a single row of search query suggestions is displayed. In alternative non-limiting embodiments of the present technology, at least two or more rows of search query suggestions are displayed. Alternatively or additionally, the number of displayed search query suggestions can be dynamic, for example, based on the subject of the search query. In other words, as the suggestion module 142 generates additional alternatives for the search query suggestions, the number of suggestions displayed in the search results interface 108 can be dynamically increased. Further, where at least two or more rows of search query suggestions are displayed, individual rows need not each include the same number of search query suggestions. Further, the type of search query suggestions displayed is not particularly limited. For example, search query suggestions may be text-based, image-based, or a mixture thereof.

Similarly, in the depicted illustrative embodiment in FIG. 2, two suggestion groups are shown—the first suggestion group 260 and the second suggestion group 280. It should be expressly understood that the number of suggestion groups is not particularly limited. Further, the number of search query suggestions included in a suggestion group is not particularly limited. A suggestion group may include one or more search query suggestions, different suggestions groups including different numbers of search query suggestions.

In some embodiments of the present technology, as depicted in FIG. 2, the search query suggestions 204, 206, and 208 are not associated with a particular search source and are displayed at the top of the list of search query suggestions 204-222. Suggestion groups 260, 280 are displayed below. However, the ordering of non-associated search query suggestions 204, 206, 208 and suggestion groups 260, 280 is not meant to be particularly limited. It should be expressly understood that non-associated search query suggestions 204, 206, 208 and suggestion groups 260, 280 may be mixed together in the list of search query suggestions in any way. Further, a list may not be vertical as depicted in FIG. 2. In some non-limiting embodiments, a suggestion group may be displayed next to another suggestion group horizontally, e.g., in a separate column. Such an organization may be particularly useful where the search query suggestions are image-based and can be displayed, for example, to the right of text-based search query suggestions. Other implementations are possible, as will be known by the person skilled in the art. It should be expressly understood that the number, type and format of search query suggestions is not particularly limited.

For the purposes of illustration, it shall be assumed that a given user is interested in learning more about Macaulay Culkin. To that end, the given user has started entering a portion of a search query “Macaulay Culkin” into the search query interface 106. According to embodiments of the present technology and, as will be described in greater detail below, the server 116 is configured to cause the search application 104 to output search query suggestions 204-222. According to the non-limiting embodiments of the present technology, the server 116 causes the search application 104 to display the search query suggestions 204-222 below the search query interface 106.

Continuing with the non-limiting example presented in FIG. 2, the given user has entered a portion of a search query “Macaulay Culkin”, specifically “Macaulay”, into the search query interface 106. In non-limiting implementations of the present technology, search query suggestions may include search query suggestions 204-222, as depicted. It will be appreciated that many other search query suggestions are possible. In the non-limiting example presented in FIG. 2, search query suggestions 204, 206, 208 are not associated with a particular search source. Search query suggestions 210, 212, 214 are associated with the search source “pictures”, and are therefore grouped together in first suggestion group 260 under the first heading 230 (“pictures”). Search query suggestions 216, 218, 220, 222 are associated with the search source “movies”, and are therefore grouped together in second suggestion group 280 under the second heading 240 (“movies”).

Now, we will turn our attention to how the server 116 generates the above-mentioned examples of search query suggestions 204-222. When the user enters a portion of the search query into the search query interface 106, the server 116 is configured to acquire an indication of the portion of the search query over the communication link 112 and to transmit the portion of the search query to the suggestion module 142. The suggestion module 142 is configured to generate one or more of the search query suggestions 204-222. In one example of a non-limiting embodiment, the suggestion module 142 can access the above-mentioned vertical search module 124. In some embodiments, the suggestion module 142 may access a plurality of vertical search modules (not depicted). Then, the suggestion module 142 first generates a plurality of vertical-derived search query suggestions, e.g., picture-based search suggestions, movie-based search suggestions, food-based search suggestions, map-based search suggestions, and the like. How the suggestion module 142 generates the search query suggestions 204-222 is not particularly limited and may include one or more of: (i) statistical popularity of a given search query suggestion based at least partially on past related search queries; (ii) user-specific popularity of the given search query suggestion; (iii) how often a particular search query suggestion is typically searched along with the search query; and (iv) other auxiliary information associated with past searches by other (or the same) user.

For example, in the above-provided example for search query “Macaulay Culkin”, search query suggestions may include suggestions for Macaulay Culkin movies, Macaulay Culkin career, Macaulay Culkin wife, Macaulay Culkin girlfriend, Macaulay Culkin family, Macaulay Culkin death hoax, Macaulay Culkin net worth, Macaulay Culkin birthplace, Macaulay Culkin hairstyle, as well as more distantly or implicitly related topics such as child actors, Christmas movies, Home Alone, celebrity bands, and the like. Search query suggestions may be directly related to the search query (for example, semantically related, obvious word additions, popular related topics, e.g., “Macaulay Culkin movies”) or may be indirectly linked to the search query (for example, topics having indirect connections to the search query, e.g., “Rachel Miner” (Macaulay Culkin's ex-wife), “Home Alone” (Macaulay Culkin's hit movie)). Search query suggestions may be text-based (e.g., the title of Macaulay Culkin's hit movie “Home Alone”) or image-based (e.g., a photo of the movie poster for “Home Alone”). After the suggestion module 142 generates the plurality of search query suggestions, the search query suggestions are ranked and then displayed to the user in accordance with the present technology, as described further below.

According to non-limiting embodiments of the present technology, the suggestion module 142 is configured to generate a plurality of search query suggestions from the at least a portion of a search query in response to the user search queries (or the at least a portion thereof) inputted via the search query interface 106. Upon receiving at least a portion of a search query from the user via the search query interface 106, the suggestion module 142 is configured to generate a ranked plurality of search query suggestions for the portion of the search query; based at least in part on an association parameter, determine whether each search query suggestion is associated with a respective search source; and, if association with a search source is determined, create a suggestion group for presenting the search query suggestions associated with the search source, as described further below. In some non-limiting embodiments, the database 134 contains the association parameter, the association parameter having been predetermined.

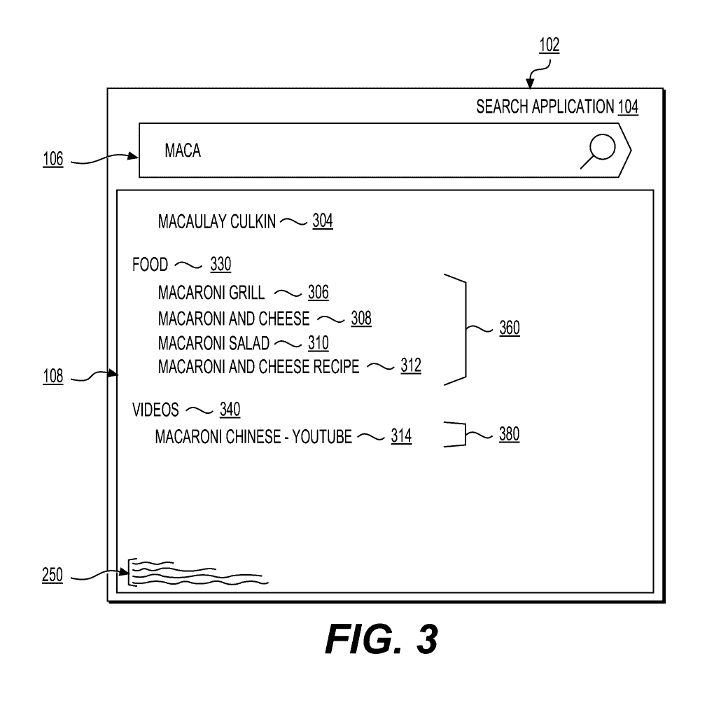

In order to fully appreciate implementations of the present technology, another non-limiting example of a screen shot of information displayed on the electronic device 102 is depicted schematically in FIG. 3. In the depicted non-limiting embodiment shown in FIG. 3, the search application 104 includes the search query interface 106 and the search results interface 108. Search query suggestions 304, 306, 308, 310, 312, and 314 are displayed. In the non-limiting embodiment shown in FIG. 3, search query suggestions 306, 308, 310, and 312 are grouped together in a first suggestion group 360 under the first heading 330 (“food”), each of the search query suggestions 306, 308, 310, and 312 in the first suggestion group being associated with the search source “food”. Search query suggestion 314 is presented in a second suggestion group 380 under the second heading 340 (“videos”), the search query suggestion 314 being associated with the search source “videos”. Thus, first suggestion group 360 presents the subset of search query suggestions associated with the search source “food”, and second suggestion group 380 presents the subset of search query suggestions associated with the search source “videos”. Search query suggestion 304 is not associated with a particular search source and is displayed in the search result page or SERP 108 separately from the suggestion groups 360, 380.

In the non-limiting embodiment depicted in FIG. 3, the given user has entered a portion of a search query “Macaulay Culkin”, specifically “maca”, into the search query interface 106. In non-limiting implementations of the present technology, search query suggestions may include search query suggestions 304-314, as depicted. It will be appreciated that many other search query suggestions are possible. In the non-limiting example presented in FIG. 3, search query suggestion 304 is not associated with a particular search source. Search query suggestions 306, 308, 310, 312 are associated with the search source “food”, and are therefore grouped together in first suggestion group 360 under the first heading 330 (“food”). Search query suggestion 314 is associated with the search source “videos”, and is therefore presented in second suggestion group 380 under the second heading 340 (“videos”).

The suggestion module 142 is configured to generate a plurality of search query suggestions for the portion of the search query entered (“maca” in the embodiment depicted in FIG. 3), and to determine, based at least in part on an association parameter, whether each search query suggestion 304, 306, 308, 310, 312, 314 is associated with a particular search source. According to non-limiting embodiments of the present technology, the server 116 is further configured to perform ranking of search query suggestions 204-222, 304-314. Ranking refers generally to identifying an order, position, or placement for search query suggestions 204-222, 304-314, relative to each other. Search query suggestions 204-222, 304-314 most relevant to a particular search query are generally provided with a higher ranking. A higher rank is used to refer to a rank that is stronger or otherwise indicates a higher priority or preference. Rankings can generally be based on any data such as, without limitation, click-through rates in query logs, history of user(s), query intent, and a combination thereof. Rankings are used to determine where search query suggestions and/or search result items should be placed, e.g., within a search results page (SERP) 108. It will be understood by those skilled in the art that rankings may or may not be personalized or user-specific, i.e., they may or may not be based on the user's personal information, such as features of the user's search history.

Thus, with reference to the examples provided in FIGS. 2 and 3, the first search query suggestion 204, 304 is ranked above the second search query suggestion 206, 306, which in turn is ranked above the third search query suggestion 208, 308, and so on. Accordingly, the first search query suggestion 204, 304 is displayed above the second search query suggestion 206, 306 which in turn is displayed above the third search query suggestion 208, 308 in the list of search query suggestions, and so on. Similarly, first suggestion group 260, 360 is ranked higher than, and displayed above, the second suggestion group 280, 380.

Given the architecture described with reference to FIG. 1 and examples provided in FIGS. 2 and 3, it is possible to execute a method for generating a list of search query suggestions for a search query or at least a portion thereof. The method of generating a list of search query suggestions can be conveniently executed on the server 116. To that end, the server includes computer usable information storage medium storing computer instructions, which instructions when executed, cause the server 116 to execute steps of the method described herein below.

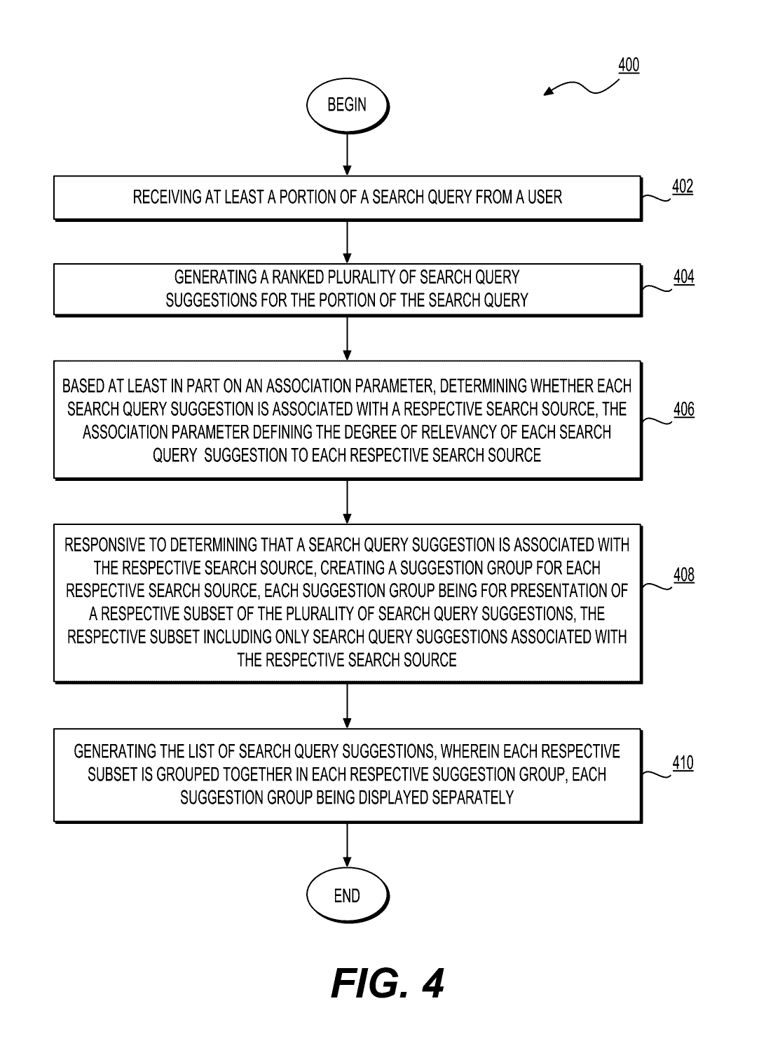

Reference will now be made to FIG. 4, which depicts a block diagram of a method 400, the method 400 being implemented in accordance with a non-limiting embodiment of the present technology.

Step 402—Receiving at Least a Portion of a Search Query from a User

The method 400 begins at step 402, where the server 116 receives a search query or at least a portion thereof from the electronic device 102 associated with the user (not depicted). The step 402 is executed in response to the user entering a search query or at least a portion of the search query into the electronic device 102 using the search query interface 106 of the search application 104. As has been mentioned above, step 402 can be executed automatically, or the user may need to indicate his or her desire to implement step 402. The indication of the desire may be received in real time (for example, by the user clicking a dedicated button) or as part of setting or set up of the search application 104. The server 116 receives the portion of the search query over the communication link 112.

In some non-limiting embodiments of the present technology, the search query or the at least a portion thereof is transmitted to the server 116 as a standard URL (i.e., a link) encoded in HTML format. In other embodiments of the present technology, the search query or the at least a portion thereof is transmitted in a MYSQ1 script. The latter is particularly useful in, but is not limited to, those non-limiting embodiments where the server 116 is implemented as an SQL server.

The method then proceeds to execution of step 404.

Step 404—Generating a Ranked Plurality of Search Query Suggestions for the Portion of the Search Query

The method 400 proceeds to step 404, where the server 116 causes the suggestion module 142 to generate a ranked plurality of search query suggestions 204-222, 304-314 related to the search query (or portion thereof). Search query suggestions may be based at least partially on past related search queries, as discussed above. For example, as has been described above, the suggestion module 142 can access one or more of the search cluster 118 and the vertical search module 124 (or a plurality of vertical search modules). Continuing with the examples provided herein, using the search query “Macaulay Culkin” or a portion thereof as an example, the suggestion module 142 may determine (based on some of the algorithms described above and based on the portion of the search query received) that search query suggestions 204-222, 304-314 include Macaulay Culkin net worth, Macaulay Culkin wife, Macauley Culkin death hoax, or macaroni and cheese recipe, etc.

Those skilled in the art will appreciate that the plurality of search query suggestions 204-222, 304-314 are typically ranked using known ranking techniques, e.g., one or more general ranking algorithm, many of which are known in the art, before search query suggestions are displayed. Search engines use a variety of methods to determine which search query suggestions are most relevant for a particular search query or portion thereof.

Those skilled in the art will appreciate that there are various techniques available for ranking and/or personalizing search query suggestions. Just as an example and not as a limitation, some of the known techniques for ranking search query suggestions by relevancy are based on some or all of: (i) popularity of a given search query suggestion or a response thereto; (ii) number of results returned for a search query suggestion; (iii) whether the search query suggestion contains any determinative terms (such as “images”, “movies”, “weather”, “YouTube™”, and the like); (iv) how often a particular search query suggestion is typically selected or used with determinative terms by other users; and (v) how often other users performing a similar search have selected a particular resource or a particular search results item when results to a particular search query suggestion were presented. Such rankings may or may not be personalized, i.e., they may or may not be based on a user-specific ranking attribute. In some implementations, such rankings of search query suggestions are based on known, general ranking techniques, and are not user-specific. In other implementations, rankings of search query suggestions are user-specific, i.e., are based on user-specific general or vertical ranking attributes. User-specific ranking attributes are based on the user's personal information, such as features of the user's search history. It should be understood that any such ranking and/or personalization techniques may be used.

The method then proceeds to execution of step 406.

Step 406—Based at Least in Part on an Association Parameter, Determining Whether Each Search Query Suggestion is Associated with a Respective Search Source, the Association Parameter Defining the Degree of Relevancy of Each Search Query Suggestion to Each Respective Search Source

The method 400 then proceeds to execution of step 406, where the server 116 causes the suggestion module 142 to determine, based at least in part on an association parameter, whether each search query suggestion is associated with a respective search source.

Many categories or types of search sources are possible and the category or type is not particularly limited. In some non-limiting embodiments of the present technology, the search source is a vertical domain. For example, the search source may be one or more of a vertical domain specific for news, images, pictures, videos, people, local businesses, items for sale, weather forecasts, maps, movies, food, recipes, etc. Many such vertical domains are possible and the search source is not meant to be particularly limited.

Generally, the association parameter defines the degree of relevancy of each search query suggestion to a particular search source, and is used to determine whether a search query suggestion is associated with a particular search source. The term “association,” as used herein, generally reflects the relevance, importance, interest, and/or applicability of a particular search query suggestion in relation to a search source.

In some non-limiting embodiments of the present technology, the association parameter is determined based on a training set of user data for past user interaction with a search query suggestion and a particular search source, in response to a search query. The association parameter is generally indicative of how often searching in a particular search source has been associated with past user searching behavior in relation to a particular search query. For example, it may be determined from past user interaction with the search query “home alone” and the vertical domain “movies” that the most relevant results for the search query “home alone” are found in the vertical domain for “movies”, i.e., the vertical domain “movies” is most relevant to users searching for the search query “home alone”. The search query “home alone” and the search source “movies” are therefore determined to be associated. Alternatively, the search query “films with Macaulay Culkin currently playing in the movie theaters” may be associated with a different search source, such as a “Movie Theater Now Playing” search service, this search source being the most relevant for the search query. In some embodiments, the association parameter is determined based on the transition history from a set of search results to the search source and back, the transition history indicating the degree of relevancy of the search query to each of the sources. Association is generally indicated by the association parameter being above a predetermined threshold for a particular pairing of search query and search source.

In some non-limiting embodiments, the association parameter is based, for example, on one or more of the following factors: click history (for example, frequency and/or duration of click throughs), popularity of past search query suggestions and/or search result items, past searching behavior, number of past search queries, number of past sessions, size of past sessions, average time between search queries, average position distance between search queries, user interest, the nature of the subject matter of the search query in question, and the like.

In another example, a past user may have inputted the search query “home alone” and, in response, been presented with a plurality of search query suggestions and/or search result items. Based at least in part on the past user's behavior with regard to the search query suggestions and/or search result items, it can be determined that the user was primarily interested in searches and search result items associated with the vertical domain “movies”, in relation to the search query “home alone”. For example, the user may have searched further or clicked through only on items relating to the vertical domain “movies”, in relation to the search query “home alone”. Based at least in part on past user behavior with respect to the search query “home alone” and the particular search source (in this example, the vertical domain “movies”), it is then determined that the particular search source is especially relevant to the search query. Association of the search query “home alone” with the particular vertical domain “movies” is then determined, and the association parameter is generated accordingly.

A “training set” refers to a collection of user data referenced from past related search queries. Referenced user data in the training set are used to determine association of a search query suggestion with a particular search source. The training set of data may be analyzed using a machine-learned model. The machine-learned model may be based on historical user search data and the like and may be based on one or more factor such as past related search queries and user behavior in relation thereto, user interest, past searching behavior, the nature of the subject matter in question, and other predetermined criteria.

Alternatively, the training set of data may be analyzed by a human judge, also referred to herein as an “assessor”. An assessor may include a single human judge or multiple judges. For example, the assessor may judge that Macaulay Culkin's movies are of high interest to users searching for “home alone”, and determine that the search query “home alone” is associated with the vertical domain for “movies” accordingly.

In some non-limiting embodiments of the present technology, an association parameter is determined with respect to a single training set of user data for a single search query. In alternative non-limiting embodiments, an association parameter is determined with respect to multiple training sets of user data for the same search query. In some non-limiting implementations, the training set of user data is user-specific. In alternative non-limiting implementations, the training set of user data is not user-specific, e.g., based on a statistical sampling of past users.

The method 400 then proceeds to execution of step 408.

Step 408—Responsive to Determining that a Search Query Suggestion is Associated with the Respective Search Source, Creating a Suggestion Group for Each Respective Search Source, Each Suggestion Group being for Presentation of a Respective Subset of the Plurality of Search Query Suggestions, the Respective Subset Including Only Search Query Suggestions Associated with the Respective Search Source

The method 400 then executes step 408, where the server 116 causes the suggestion module 142 to create a suggestion group for each respective search source, responsive to determining that a search query suggestion is associated with the respective search source. Generally, a search query suggestion is determined to be associated with a respective search source if the association parameter is above a predetermined threshold, the association parameter having been predetermined as discussed above.

Each suggestion group is created for presentation of a respective subset of the plurality of search query suggestions 204-222, 304-314, the respective subset including only search query suggestions associated with the respective search source. Thus, in the non-limiting embodiment shown in FIG. 2, the first suggestion group 260 is created for the search source “pictures”. The first suggestion group 260 is for presentation of the subset of the plurality of search query suggestions including the fourth search query suggestion 210, the fifth search query suggestion 212, and the sixth search query suggestion 214, each of which has been determined to be associated with the search source “pictures”. Only search query suggestions 210, 212, 214 that are associated with the search source “pictures” are included in the first suggestion group 260 for the search source “pictures”.

Similarly, in the non-limiting embodiment shown in FIG. 2, the second suggestion 280 is created for the search source “movies”. The second suggestion group 280 is for presentation of the subset of the plurality of search query suggestions including the seventh search query suggestion 216, the eighth search query suggestion 218, the ninth search query suggestion 220, and the tenth search query suggestion 222, each of which has been determined to be associated with the search source “movies”. Only search query suggestions 216, 218, 220, 222 that are associated with the search source “movies” are included in the second suggestion group 280 for the search source “movies”.

The number of suggestion groups 260, 280, 360, 380 created is not particularly limited and will vary, depending on a number of factors such as the subject matter of the search query, the number of search query suggestions 204-222, 304-314 generated, the space available for display of the search query suggestions 204-222, 304-314, the number of different search sources associated with search query suggestions 204-222, 304-314, and the like. In some non-limiting embodiments, one suggestion group 260, 280, 360, 380 is created.

In alternative non-limiting embodiments of the present technology, as depicted in FIGS. 2 and 3, two or more suggestions groups 260, 280, 360, 380 are created, in which case each suggestion group 260, 280, 360, 380 is associated with a unique search source.

Similarly, the number of search query suggestions 204-222, 304-314 included in a suggestion group 260, 280, 360, 380 is not particularly limited and will vary, depending on a number of factors such as the subject matter of the search query, the number of search query suggestions 204-222, 304-314 generated, the space available for display of the search query suggestions 204-222, 304-314, and the like. Only search query suggestions 204-222, 304-314 associated with the search source for a particular suggestion group 260, 280, 360, 380 are included in that particular suggestion group. In some non-limiting embodiments, a suggestion group includes two or more search query suggestions. For example, as shown in FIGS. 2 and 3, suggestion groups 260, 280, 360 each include two or more search query suggestions 210, 212, 214, 216, 218, 220, 222, 306, 308, 310, 312. In alternative non-limiting embodiments, a suggestion group may include only one search query suggestion. For example, as shown in FIG. 3, suggestion group 380 includes one search query suggestion 314. In further non-limiting embodiments, the number of search query suggestions 204-222, 304-314 included in a suggestion group 260, 280, 360, 380 may be pre-set, e.g., it may be pre-set that a suggestion group will include a maximum (or minimum) number of search query suggestions.

In some cases, it may be determined that a search query suggestion is not associated with a particular search source. In this case, the search query suggestion is not included in an existing suggestion group, nor would a new suggestion group be created. For example, in FIGS. 2 and 3, search query suggestions 204, 206, 208, 304 are not included in a suggestion group 260, 280, 360, 380. Such non-associated search query suggestions 204, 206, 208, 304 are maintained in the plurality of search query suggestions 204-222, 304-314, separately from the suggestion groups 260, 280, 360, 380.

The method 400 next proceeds to execution of step 410.

Step 410—Generating the List of Search Query Suggestions, Wherein Each Respective Subset is Grouped Together in Each Respective Suggestion Group, Each Suggestion Group being Displayed Separately

In step 410, the list of search query suggestions is generated. In the list, each respective subset is grouped together in each respective suggestion group 260, 280, 360, 380. For example, in the non-limiting embodiment depicted in FIG. 2, the subset of search query suggestions 210, 212, 214 associated with the first search source “pictures” is grouped together in the first suggestion group 260, the first suggestion group 260 being for presentation of search query suggestions 210, 212, 214 associated with the search source “pictures”. Only search query suggestions 210, 212, 214 associated with the search source “pictures” are included in the first suggestion group 260. Similarly, only search query suggestions 216, 218, 220, 222 associated with the search source “movies” are included in the second suggestion group 280. In some non-limiting embodiments, as shown in FIG. 2, a suggestion group 260, 280 includes two or more search query suggestions. In alternative non-limiting embodiments, as shown in FIG. 3, a suggestion group 380 includes one search query suggestion 314. The number of search query suggestions included in a suggestion group will vary, depending on a number of factors such as the subject matter of the search query, the number of search query suggestions generated, the space available for display of the search query suggestions, and the like.

The number of suggestion groups 260, 280, 360, 380 created and presented in the list will also vary, depending on a number of factors such as the subject matter of the search query, the number of search query suggestions generated, the space available for display of the search query suggestions, and the like. In some non-limiting embodiments, one suggestion group is included in the list. In alternative non-limiting embodiments of the present technology, as depicted in FIGS. 2 and 3, two or more suggestions groups 260, 280, 360, 380 are included in the list. In embodiments where more than one suggestion group 260, 280, 360, 380 is created, each suggestion group is displayed separately in the list. For example, it can be seen in FIGS. 2 and 3, that suggestion groups 260, 280, 360, 380 are displayed separately from each other. It should be expressly understood that the ordering or arrangement of the suggestion groups 260, 280, 360, 380 is not particularly limited. As discussed above, suggestion groups may be ranked using known ranking criteria, mixed with non-associated search query suggestions 204, 206, 208, 304 and so on.

In some non-limiting implementations of the present technology, each suggestion group 260, 280, 360, 380 in the list is presented with a heading 230, 240, 330, 340. In each case, the heading 230, 240, 330, 340 indicates the search source associated with the respective suggestion group 260, 280, 360, 380, the search query suggestions 210-222, 304-312 in the respective suggestion group all being grouped together under the respective heading.

In some non-limiting implementations of the present technology, the method 400 further comprises the step of causing the list of search query suggestions 204-222, 304-314 to be displayed to the user. For example, the list of search query suggestions 204-222, 304-314 may be displayed on the search results interface 108, as depicted in FIGS. 2 and 3. In some non-limiting embodiments, the search query suggestions 204-222, 304-314 are displayed to the user while the user is entering the at least a portion of the search query. For example, the user may have entered only a partial search query, or may be in the process of entering the search query. Continuing with the above examples, the user may have entered only “macaulay” (FIG. 2) or “maca” (FIG. 3) in the search query interface 106. In alternative non-limiting implementations, the search query suggestions are displayed to the user after the user has completed entering the at least a portion of the search query, but before the search has been executed. For example, the user has entered “Macaulay Caulkin” in the search query interface 106, but the search has not yet been executed. In further non-limiting embodiments, search query suggestions may be updated as the user is in the process of entering the search query, being updated as the user continues typing.

It should be expressly understood that the display of the search query suggestions 204-222, 304-314 to the user is not particularly limited. For example, the number, the location, and the format of search query suggestions are not limited. Similarly, the number, the location, and the format of suggestion groups are not limited.

In some non-limiting implementations of the present technology, after causing the list of search query suggestions 204-222, 304-314 to be displayed to the user, the method 400 further comprises the step of, responsive to the user selecting a search query suggestion presented in a particular suggestion group, executing a search of the search source associated with that particular suggestion group. For example, with reference to FIG. 2, suppose the user selects (e.g., clicks on) the fourth search query suggestion 210 (“macaulay culkin 2014”). The fourth search query suggestion 210 is presented in the first suggestion group 260, which is associated with the first search source “pictures” (as indicated by the first heading 230 “pictures” displayed above the first suggestion group 260, the search query suggestions 210, 212, 214 being grouped together under the first heading 230 in the non-limiting embodiment shown in FIG. 2). Accordingly, responsive to the user selecting the fourth search query suggestion 210, a search for macaulay culkin 2014 is executed in the vertical domain for pictures. Similarly, responsive to the user selecting the seventh search query suggestion 216 (“home alone”), a search for home alone is executed in the vertical domain for movies, the seventh search query suggestion 216 being included in the second suggestion group 280 that is associated with the search source “movies”. In such implementations, the method can provide more efficient delivery of a specific type of search results for the user. For example, in such embodiments, the search efficiency may be improved by “click economy”, the user being required only to select, e.g., click, a particular search query suggestion in order to execute the search of the associated search source.

Some technical effects of non-limiting embodiments of the present technology may include provision of desired search query suggestions to the user, in response to the user entering at least a portion of a search query, clustered in suggestion groups. This clustering of search query suggestions in suggestion groups can assist the user delving more deeply into a subject of interest quickly. This provision may further allow the user to find more efficiently the information he or she is looking for. Allowing the user to more efficiently find information may also result in less bandwidth usage. Also, with the electronic device 102 being implemented as a wireless communication device, ability to more efficiently find information would result in conservation of battery power of the electronic device 102. In some embodiments, the present technology may provide click efficiency, reducing the number of clicks required to execute a search of the desired search source (e.g., vertical domain) for a particular search query.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

From one perspective, embodiments of the present technology described above can be summarized as follows, structured in numbered clauses:

CLAUSE 1. A method (400) for generating a list of search query suggestions, the method executable at a server (116), the method comprising:

a) receiving at least a portion of a search query from a user;

b) generating a ranked plurality of search query suggestions (204-222, 304-314) for the portion of the search query;

c) based at least in part on an association parameter, determining whether each search query suggestion (204-222, 304-314) is associated with a respective search source, the association parameter defining the degree of relevancy of each search query suggestion (204-222, 304-314) to each respective search source;

d) responsive to determining that a search query suggestion (204-222, 304-314) is associated with the respective search source, creating a suggestion group (260, 280, 360, 380) for each respective search source, each suggestion group (260, 280, 360, 380) being for presentation of a respective subset of the plurality of search query suggestions (204-222, 304-314), the respective subset including only search query suggestions associated with the respective search source; and

e) generating the list of search query suggestions, wherein each respective subset is grouped together in each respective suggestion group (260, 280, 360, 380), each suggestion group (260, 280, 360, 380) being displayed separately.

CLAUSE 2. The method of clause 1, wherein two or more suggestion groups (260, 280, 360, 380) are created, each suggestion group (260, 280, 360, 380) associated with a unique respective search source.

CLAUSE 3. The method of clause 1, wherein, for one or more suggestion group (260, 280, 360), the respective subset associated with the respective suggestion group (260, 280, 360,) includes two or more search query suggestions (210-214, 216-222, 306-312).

CLAUSE 4. The method of any one of clauses 1 to 3, further comprising the step of causing the list of search query suggestions to be displayed to the user.

CLAUSE 5. The method of clause 4, further comprising the step of, responsive to the user selecting a search query suggestion (204-222, 304-314) presented in the respective suggestion group (260, 280, 360, 380), executing a search of the respective search source associated with the respective suggestion group ( ), 260, 280, 360, 380).

CLAUSE 6. The method of any one of clauses 3 to 5, further comprising the step of, responsive to determining that a search query suggestion (204, 206, 208, 304) is not associated with the respective search source, causing the non-associated search query suggestion (204, 206, 208, 304) to be displayed in the list separately from each suggestion group (260, 280, 360, 380), such that suggestion groups (260, 280, 360, 380) and non-associated search query suggestions (204, 206, 208, 304) are mixed together in the list.

CLAUSE 7. The method of any one of clauses 1 to 6, wherein association between a search query suggestion (204-222, 304-314) and the respective search source is indicated by the association parameter being above a predetermined threshold

CLAUSE 8. The method of any one of clauses 1 to 7, wherein the association parameter has been predetermined based on a training set of user data for past user interaction with a search query suggestion (204-222, 304-314) and the respective search source in response to the past user having inputted the search query.

CLAUSE 9. The method of any one of clauses 1 to 8, wherein each suggestion group (260, 280, 360, 380) is presented with a heading (230, 240, 330, 340) indicating the respective associated search source, the respective subset of search query suggestions (204-222, 304-314) associated with the respective search source being grouped together under the respective heading (230, 240, 330, 340).

CLAUSE 10. The method of any one of clauses 1 to 9, wherein the search source is a vertical search domain.

CLAUSE 11. The method of clause 10, wherein the vertical search domain is for one or more of news, images, pictures, videos, people, local businesses, items for sale, weather forecasts, maps, movies, food, and recipes.

CLAUSE 12. The method of any one of clauses 8 to 11, wherein the training set of user data comprises historical user search data.

CLAUSE 13. The method of any one of clauses 8 to 11, wherein the training set of user data comprises user-specific search data.

CLAUSE 14. A server (116) comprising:

a communication interface for communication with an electronic device (102) associated with a user via a communication network (112);

a memory storage;

a processor operationally connected with the communication interface and the memory storage, the processor configured to store objects, in association with the user, on the memory storage, the processor being further configured to:

a) receive at least a portion of a search query from a user;

b) generate a ranked plurality of search query suggestions (204-222, 304-314) for the portion of the search query;

c) based at least in part on an association parameter, determine whether each search query suggestion (204-222, 304-314) is associated with a respective search source, the association parameter defining the degree of relevancy of each search query suggestion (204-222, 304-314) to each respective search source;

d) responsive to determining that a search query suggestion (204-222, 304-314) is associated with the respective search source, create a suggestion group (260, 280, 360, 380) for each respective search source, each suggestion group (260, 280, 360, 380) being for presentation of a respective subset of the plurality of search query suggestions (204-222, 304-314), the respective subset including only search query suggestions (204-222, 304-314) associated with the respective search source; and

e) generate the list of search query suggestions (204-222, 304-314), wherein each respective subset is grouped together in each respective suggestion group (260, 280, 360, 380), each suggestion group (260, 280, 360, 380) being displayed separately.

CLAUSE 15. The server of clause 14, wherein two or more suggestion groups (260, 280, 360, 380) are created, each suggestion group (260, 280, 360, 380) associated with a unique respective search source.

CLAUSE 16. The server of clause 14, wherein, for one or more suggestion group (260, 280, 360), the respective subset associated with the respective suggestion group (260, 280, 360) includes two or more search query suggestions (210-214, 216-222, 306-312).

CLAUSE 17. The server of any one of clauses 14 to 16, wherein the processor is further configured to cause the list of search query suggestions to be displayed to the user.

CLAUSE 18. The server of clause 17, wherein the processor is further configured to, responsive to the user selecting a search query suggestion (204-222, 304-314) presented in the respective suggestion group (260, 280, 360, 380), execute a search of the respective search source associated with the respective suggestion group (260, 280, 360, 380).

CLAUSE 19. The server of any one of clauses 16 to 18, wherein the processor is further configured to, responsive to determining that a search query suggestion (204, 206, 208, 304) is not associated with the respective search source, cause the non-associated search query suggestion (204, 206, 208, 304) to be displayed in the list separately from each suggestion group (260, 280, 360, 380), such that suggestion groups (260, 280, 360, 380) and non-associated search query suggestions (204, 206, 208, 304) are mixed together in the list.

CLAUSE 20. The server of any one of clauses 14 to 19, wherein association between a search query suggestion (204-222, 304-314) and the respective search source is indicated by the association parameter being above a predetermined threshold.

CLAUSE 21. The server of any one of clauses 14 to 20, wherein the association parameter has been predetermined based on a training set of user data for past user interaction with a search query suggestion (204-222, 304-314) and the respective search source in response to the past user having inputted the search query.

CLAUSE 22. The server of any one of clauses 14 to 21 wherein each suggestion group (260, 280, 360, 380) is presented with a heading (230, 240, 330, 340) indicating the respective associated search source, the respective subset of search query suggestions (210, 212, 214, 216, 218, 220, 222, 306, 308, 310, 312, 314) associated with the respective search source being grouped together under the respective heading.

CLAUSE 23. The server of any one of clauses 14 to 22, wherein the search source is a vertical search domain.

CLAUSE 24. The server of clause 23, wherein the vertical search domain is for one or more of news, images, pictures, videos, people, local businesses, items for sale, weather forecasts, maps, movies, food, and recipes.

CLAUSE 25. The server of any one of clauses 21 to 24, wherein the training set of user data comprises historical user search data.

CLAUSE 26. The server of any one of clauses 21 to 24, wherein the training set of user data comprises user-specific search data.

1. A method for generating a list of search query suggestions, the method executable at a server, the method comprising:
a) receiving at least a portion of a search query from a user;
b) generating a ranked plurality of search query suggestions for the portion of the search query;
c) based at least in part on an association parameter, determining whether each search query suggestion is associated with a respective search source, the association parameter defining the degree of relevancy of each search query suggestion to each respective search source;
d) responsive to determining that a search query suggestion is associated with the respective search source, creating a suggestion group for each respective search source, each suggestion group being for presentation of a respective subset of the plurality of search query suggestions, the respective subset including only search query suggestions associated with the respective search source; and
e) generating the list of search query suggestions, wherein each respective subset is grouped together in each respective suggestion group, each suggestion group being displayed separately.

2. The method of claim 1, wherein two or more suggestion groups are created, each suggestion group associated with a unique respective search source.

3. The method of claim 1, wherein, for one or more suggestion group, the respective subset associated with the respective suggestion group includes two or more search query suggestions.

4. The method of claim 1, further comprising the step of causing the list of search query suggestions to be displayed to the user and further comprising the step of, responsive to the user selecting a search query suggestion presented in the respective suggestion group, executing a search of the respective search source associated with the respective suggestion group.

5. The method of claim 3, further comprising the step of, responsive to determining that a search query suggestion is not associated with the respective search source, causing the non-associated search query suggestion to be displayed in the list separately from each suggestion group, such that suggestion groups and non-associated search query suggestions are mixed together in the list.

6. The method of claim 1, wherein the association parameter has been predetermined based on a training set of user data for past user interaction with a search query suggestion and the respective search source in response to the past user having inputted the search query.

7. The method of claim 1, wherein each suggestion group is presented with a heading indicating the respective associated search source, the respective subset of search query suggestions associated with the respective search source being grouped together under the respective heading.

8. The method of claim 1, wherein the search source is a vertical search domain and wherein the vertical search domain is for one or more of news, images, pictures, videos, people, local businesses, items for sale, weather forecasts, maps, movies, food, and recipes.

9. The method of claim 6, wherein the training set of user data comprises historical user search data.

10. The method of claim 6, wherein the training set of user data comprises user-specific search data.

11. A server comprising:
a communication interface for communication with an electronic device associated with a user via a communication network;
a memory storage;
a processor operationally connected with the communication interface and the memory storage, the processor configured to store objects, in association with the user, on the memory storage, the processor being further configured to:
a) receive at least a portion of a search query from a user;
b) generate a ranked plurality of search query suggestions for the portion of the search query;
c) based at least in part on an association parameter, determine whether each search query suggestion is associated with a respective search source, the association parameter defining the degree of relevancy of each search query suggestion to each respective search source;
d) responsive to determining that a search query suggestion is associated with the respective search source, create a suggestion group for each respective search source, each suggestion group being for presentation of a respective subset of the plurality of search query suggestions, the respective subset including only search query suggestions associated with the respective search source; and
e) generate the list of search query suggestions, wherein each respective subset is grouped together in each respective suggestion group, each suggestion group being displayed separately.

12. The server of claim 11, wherein two or more suggestion groups are created, each suggestion group associated with a unique respective search source.

13. The server of claim 11, wherein, for one or more suggestion group, the respective subset associated with the respective suggestion group includes two or more search query suggestions.

14. The server of claim 11, wherein the processor is further configured to cause the list of search query suggestions to be displayed to the user and wherein the processor is further configured to, responsive to the user selecting a search query suggestion presented in the respective suggestion group, execute a search of the respective search source associated with the respective suggestion group.

15. The server of claim 13, wherein the processor is further configured to, responsive to determining that a search query suggestion is not associated with the respective search source, cause the non-associated search query suggestion to be displayed in the list separately from each suggestion group, such that suggestion groups and non-associated search query suggestions are mixed together in the list.

16. The server of claim 11, wherein the association parameter has been predetermined based on a training set of user data for past user interaction with a search query suggestion and the respective search source in response to the past user having inputted the search query.

17. The server of claim 11, wherein each suggestion group is presented with a heading indicating the respective associated search source, the respective subset of search query suggestions associated with the respective search source being grouped together under the respective heading.

18. The server of claim 11, wherein the search source is a vertical search domain and wherein the vertical search domain is for one or more of news, images, pictures, videos, people, local businesses, items for sale, weather forecasts, maps, movies, food, and recipes.

19. The server of claim 16, wherein the training set of user data comprises historical user search data.

20. The server of claim 16, wherein the training set of user data comprises user-specific search data.
